(19) United States
(12) Patent Application Publication
(10) Pub. No.: US 2020/0038875 A1
(43) Pub. Date: Feb. 6, 2020

(54) METAL SCRAP SHREDDER HAVING VARIABLE SPEED FUNCTION

(71) Applicant: Chip Systems International, Scotts, MI (US)

(72) Inventor: Russell Dean Dudley, Kalamazoo, MI (US)

(21) Appl. No.: 16/053,251

(22) Filed: Aug. 2, 2018

(51) Int. Cl. B02C 25/00; B02C 18/22; B02C 23/10

(52) U.S. Cl. CPC B02C 25/00; B02C 23/10; B02C 18/2258

(57) ABSTRACT

A shredding apparatus for separating scrap material includes a conveyor that delivers agglomerations of metal scrap from a collection area to a conveyor outlet where a shredding tool is positioned. The shredding tool is rotationally operable between a plurality of shredding speeds and includes teeth that shred the agglomerations of metal scrap for delivery to an outlet section. A variable speed motor rotationally operates the shredding tool to selectively define the plurality of shredding speeds. A sensor is positioned proximate one of the shredding tool and the conveyor. The sensor monitors a density of the agglomerations of metal scrap. A controller is in communication with the sensor and the motor. The sensor communicates the density of the agglomerations to the controller and the controller modulates an operational speed of the variable speed motor based upon the density of the agglomerations.

### FIELD OF THE INVENTION

The present invention generally relates to scrap shredders, and more specifically, a scrap material shredder that can variably adjust operating speeds based upon a density of the scrap material being processed within the assembly.

### BACKGROUND OF THE INVENTION

Agglomerated scrap material can be a natural byproduct of metal machining operations. Typically, the agglomerated scrap material is laden with liquid used to lubricate and cool cutting tools performing the machining operations. It is important to recover and reuse as much of the liquid as possible since the liquid is expensive, and further since it can be difficult and expensive to dispose of scrap that includes the liquid in an environmentally safe manner. Additionally, much of the scrap can be agglomerated in portions of scrap that have various densities that are to be separated for disposal. These various densities of the scrap material can contain varying amounts of material that need to be recovered for reuse.

### SUMMARY OF THE INVENTION

According to one aspect of the present invention, a shredding apparatus for separating scrap material includes a conveyor that delivers agglomerations of metal scrap from a collection area to a conveyor outlet. A shredding tool is positioned proximate the conveyor outlet. The shredding tool is rotationally operable between a plurality of shredding speeds and wherein the shredding tool includes a plurality of teeth that shred the agglomerations of metal scrap for delivery to an outlet section. A variable speed motor is coupled with the shredding tool. The variable speed motor rotationally operates the shredding tool to selectively define the plurality of shredding speeds. A sensor is positioned proximate one of the shredding tool and the conveyor, wherein the sensor monitors a density of the agglomerations of metal scrap. A controller is in communication with the sensor and the variable speed motor. The sensor communicates the density of the agglomerations of metal scrap to the controller and the controller modulates an operational speed of the variable speed motor based upon the density of the agglomerations of metal scrap.

According to another aspect of the present invention, a shredding apparatus for separating scrap material includes a screw-type conveyor that delivers agglomerations of metal scrap from a collection area to a conveyor outlet. A shredding tool is positioned proximate the conveyor outlet. The shredding tool includes a plurality of teeth that shred the agglomerations of metal scrap for delivery to an outlet section. A sensor is positioned proximate one of the shredding tool and the screw-type conveyor. The sensor monitors a density of the agglomerations of metal scrap within the screw-type conveyor to define a sensed density. A variable speed motor is coupled with the shredding tool. Operation of the variable speed motor rotationally operates the shredding tool to selectively define a plurality of operating speeds of the shredding tool, wherein the sensed density of the agglomerations of metal scrap defines the operating speed of the variable speed motor and the shredding tool.

According to another aspect of the present invention, a method of shredding scrap material includes delivering agglomerations of metal scrap from a collection area to a conveyor outlet via a screw-type conveyor and detecting the density of the agglomerations of metal scrap within the screw-type conveyor using a sensor. The method also includes modulating a speed of a motor in response to a sensed density of the agglomerations of metal scrap, wherein the speed of the motor is modulated before a blockage reaches the conveyor outlet. The method also includes shredding the agglomerations of metal scrap using a shredding tool located proximate the conveyor outlet, wherein the sensor is one of a decibel sensor and a torque sensor that is attached to the shredding tool and discharging shredded metal scrap from the shredding tool to a scrap separator.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a cross-sectional view of an aspect of a scrap shredding apparatus shown in operation;

FIG. 2 is an enlarged cross-sectional view of the scrap shredding apparatus of FIG. 1, taken at area II;

FIG. 3 is a schematic cross-sectional view of an aspect of the scrap shredding apparatus and showing interaction of the conveyor and shredding tool at the conveyor outlet;

FIG. 4 is an elevational view of an aspect of the shredding tool for use in the shredding apparatus;

FIG. 5 is a schematic cross-sectional view of the scrap shredding apparatus and exemplifying a low density of scrap material being processed;

FIG. 6 is a cross-sectional view of an aspect of the scrap shredding apparatus and showing a pocket of higher density of scrap material being processed;

FIG. 7 is a schematic cross-sectional view of a scrap shredding apparatus showing operation of a sensor and controller for modulating operation of the motor and the shredding tool; and

FIG. 8 is a linear flow diagram illustrating a method of shredding agglomerations of scrap material utilizing a variable speed motor.

### DETAILED DESCRIPTION OF THE PREFERRED EMBODIMENTS

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

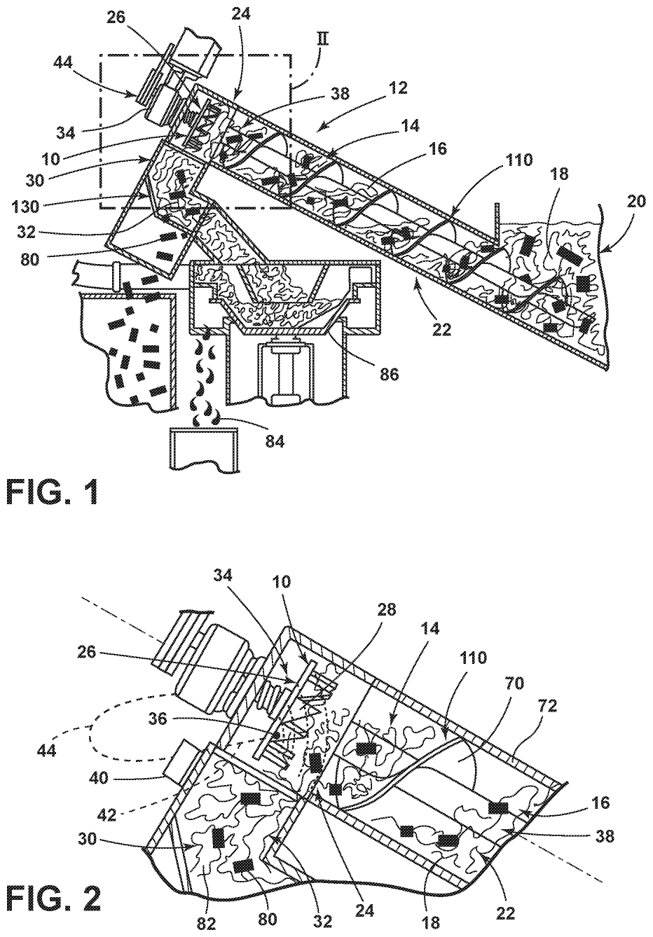

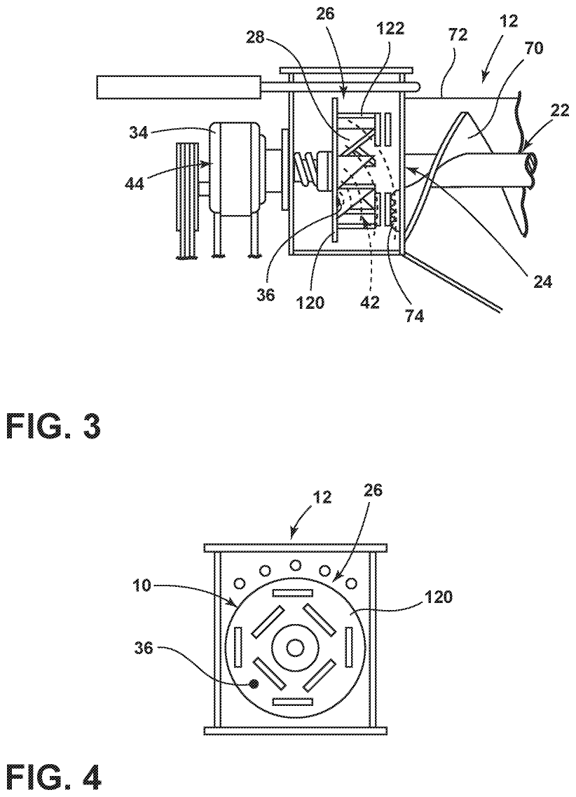

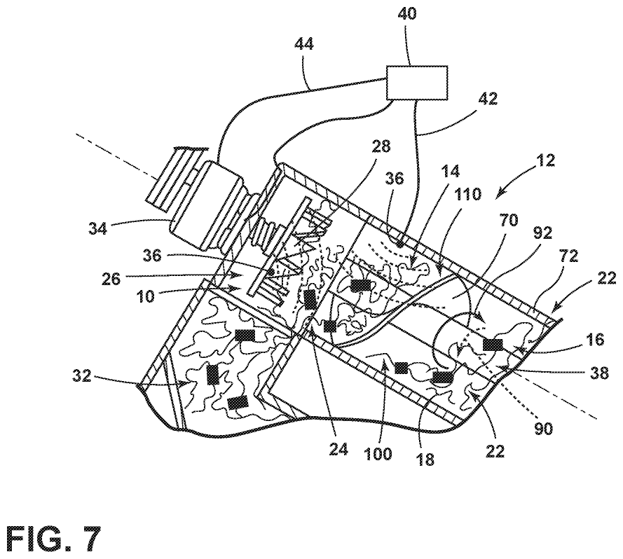

As exemplified in FIGS. 1-7, reference numeral 10 generally refers to a shredding tool that is rotationally operable within a shredding apparatus 12 for processing loose particles and agglomerations 14 of scrap material 16. Typically, the scrap material 16 is in the form of metal scraps 18 that are generated as a byproduct during metal machining processes. These metal scraps 18 are then placed in a collection area 20 and processed using the shredding apparatus 12. During processing, the agglomerations 14 of scrap material 16 are separated based upon various criteria, such as scrap size, liquid versus solid, densities, and other similar criteria. According to various aspects of the device, the shredding apparatus 12 includes a conveyor 22 that delivers the agglomerations 14 of scrap material 16 from the collection area 20 to a conveyor outlet 24. The shredding tool 10 is positioned proximate the conveyor outlet 24. The shredding tool 10 is rotationally operable between the plurality of shredding speeds 26 and includes a plurality of teeth 28 that are configured to shred the agglomerations 14 of scrap material 16 for delivery to an outlet section 30. After leaving the outlet section 30, the processed material 32 can be separated into various categories, similar to those described above. A variable speed motor 34 is coupled with the shredding tool 10. Operation of the variable speed motor 34 rotationally operates the shredding tool 10 to selectively define the plurality of shredding speeds 26. A sensor 36 is positioned proximate or near the shredding tool 10 or the conveyor 22, or both. The sensor 36 monitors a density 38 of the agglomerations 14 of scrap material 16 as the scrap material 16 moves through the conveyor 22 and approaches the shredding tool 10 at the conveyor outlet 24. A controller 40 is in communication with the sensor 36 and the variable speed motor 34. The sensor 36 communicates the density 38, typically as a sensed density 42, of the agglomerations 14 of scrap material 16 to the controller 40. The controller 40 modulates the operational speed 44 of the variable speed motor 34 based upon the sensed density 42 of the agglomerations 14 of scrap material 16, typically metal scraps 18.

Referring again to FIGS. 1-7, during operation of the shredding apparatus 12, the sensor 36 and controller 40 operate cooperatively to define the various operational speeds 44 of the variable speed motor 34. By way of example, and not limitation, a first operating speed 50 of the motor 34 can be set in response to a sensed density 42 of the agglomerations 14 of scrap material 16 having a first density 52, such as a lower density 62. As described above, the sensed density 42 of the agglomerations 14 is sensed by the sensor 36. Similarly, the sensor 36 and the controller 40 can cooperatively operate to define a second operating speed 54 of the variable speed motor 34 in response to the sensed density 42 of the agglomerations 14 of scrap material 16 having a second density 56, such as a higher density 60. In this manner, the first operating speed 50 of the motor 34 can be faster than the second operating speed 54. These various operational speeds 44 can be performed in response to the various densities of the agglomerations 14 of scrap material 16. In this manner, the second density 56 of the agglomerations 14 of scrap material 16 may be greater or more dense than the first density 52 of the agglomerations 14 of scrap material 16.

During operation of the shredding apparatus 12, various densities of the agglomerations 14 will be moved through the conveyor 22 and toward the shredding tool 10. During this movement of the agglomerations 14, and other loose particles of scrap material 16, the sensor 36 monitors the varying density 38 of the scrap material 16, including the various agglomerations 14. Where the agglomerations 14 of scrap material 16 have a higher density 60, the sensor 36 cooperates with the controller 40 and the motor 34 to decrease the operational speed 44 of the motor 34 and the shredding speed 26 of the shredding tool 10. It has been found through investigation of the device that slower shredding speeds 26 of the shredding tool 10 tend to perform more efficiently at shredding agglomerations 14 having a higher density 60. Where the agglomerations 14 have a lower density 62, or where primarily loose scrap material 16 is present, the controller 40 and the sensor 36 cooperate to operate the motor 34 at a higher operational speed 44 and the shredding tool 10 at a higher shredding speed 26. The higher operational speed 44 has been shown to be proficient at separating agglomerations 14 having a lower density 62 or portions of the scrap material 16 having a generally lower density 62. Operation of the sensor 36 in connection with the controller 40 and the motor 34 will be described more fully below.

Referring again to FIGS. 1-3, the conveyor 22 for the shredding apparatus 12 can include an auger 70 or a screw-type conveyor 22 that is rotationally operable within a conveyor housing 72. As the auger 70 operates, the scrap material 16 is translated through the conveyor housing 72 and toward the conveyor outlet 24. The auger 70 typically includes an end section 74 that is positioned proximate the conveyor outlet 24. The plurality of teeth 28 of the shredding tool 10 cooperate with the end section 74 of the auger 70 to shred the agglomerations 14 of scrap material 16 for delivery to the outlet section 30. As described previously, within the outlet section 30, scrap material 16 can be separated into different categories. As exemplified in FIG. 1, which shows metal scrap 18 as the scrap material 16, the different categories include larger chunks 80 of metal scrap 18, smaller particles 82 of metal scrap 18, and lubricating fluid 84 that can be used during various metal machining processes. This lubricating fluid 84 can be captured and reused for future metal machining processes. Within the outlet section 30, a centrifuge 86 can be positioned to receive shredded metal scrap 18 from the shredding tool 10. The centrifuge 86 can be configured to separate and remove lubricating fluid 84 from the processed material 32.

Referring again to FIGS. 1-7, the sensor 36 for the shredding apparatus 12 can take the form of any one of various sensors 36. Such sensors 36 can include, but are not limited to, a torque sensor, a noise sensor, a vibration sensor, various weight scales, movement sensors, accelerometers, optical sensors, ultra-sound sensors, laser sensors, infrared sensors, combinations thereof and other similar sensors that can be used to detect various characteristics of the agglomerations 14 of scrap material 16 moving through the conveyor 22 and toward the shredding tool 10.

According to various aspects of the device, where the sensor 36 is a torque sensor, the torque sensor can be attached to a portion of the auger 70, the shredding tool 10, or sensors 36 can be coupled with each. During operation of the shredding apparatus 12, agglomerations 14 having a higher density 60 can cause the auger 70 and/or the shredding tool 10 to experience a greater resistance 90 to rotational movement. As the sensor 36 detects or measures this resistance 90 to rotational movement, the sensor 36 communicates to the motor 34, typically via the controller 40, that an agglomeration 14 having a higher density 60 is moving through the shredding apparatus 12. The controller 40 communicates with the auger 70 and/or the motor 34, to slow the rotational operation of the auger 70 and/or the shredding tool 10. Slowing the rotation of the shredding tool 10 may also, in various embodiments, increase the torque 92 applied by the shredding tool 10 against the agglomerations 14 of scrap material 16 having a higher density 60.

In various aspects of the device, agglomerations 14 of scrap material 16 having a higher density 60 may also cause greater vibration 100 or other noise within the shredding assembly. Accordingly, the sensor 36 may take the form of a vibration sensor or noise sensor, such as a decibel sensor, that can detect these added vibrations 100 and/or noises that may be experienced when an agglomeration of scrap material 16 having a higher density 60 is moved through the conveyor 22 toward the shredding tool 10. These vibrations 100 or noises can increase such that the vibrations 100 or noises are indicative of agglomerations 14 having the second higher density 60.

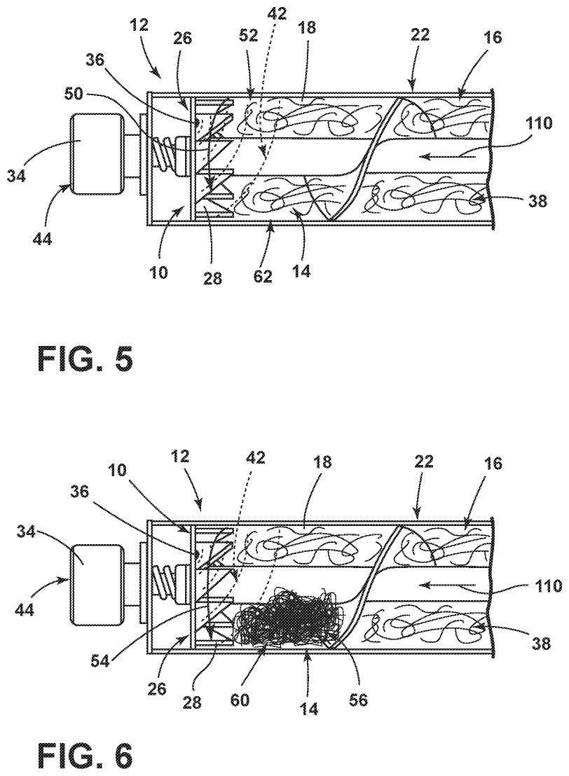

As exemplified in FIGS. 5-7, use of the sensor 36 is configured to monitor, directly or indirectly, the agglomerations 14 of scrap material 16 having higher or lower densities 60, 62 so that the operational speed 44 of the motor 34 and the shredding speed 26 of the shredding tool 10 can be modulated before the agglomeration reaches the shredding tool 10. In this manner, the sensor 36 or sensors 36 can be utilized to adjust the shredding speed 26 of the shredding tool 10 before a particular agglomeration 14 having a higher density 60 or potentially a lower density 62 reaches the shredding tool 10.

In conventional scrap shredders, higher densities of metal scrap are addressed by stopping the assembly and backing up or reversing the flow of the assembly so that the agglomeration of metal scrap can be removed, displaced, or otherwise manipulated so that the scrap shredder can continue to process the material. By reversing the flow of the scrap material, the flow for processing the scrap material is slowed significantly. Additionally, these conventional shredders typically wait for a blockage to reach the tool for the apparatus before the system is reversed. In such an instance, the tool may be completely blocked or totally stopped as a result of the increased density of the scrap being processed. Removal of these blockages may take significant amounts of time that can further delay the processing of scrap by the conventional apparatus.

Referring again to FIGS. 1-7, by utilizing the sensors 36 to predict or anticipate the processing of agglomerations 14 of scrap material 16 having a higher density 60, the performance of the shredding tool 10 can be modulated to a shredding speed 26 that is better equipped to process the various agglomerations 14 of scrap material 16. The operation or delivery speed 110 of the conveyor 22 may also be increased or decreased to address agglomerations 14 of scrap material 16 having higher or lower densities 60, 62. Utilizing the sensors 36 and the variable speed motor 34, the shredding apparatus 12 can continually move the scrap material 16 in a forward direction for continual processing without reversing the flow of the scrap material 16 to address blockages.

According to various aspects of the device, the sensor 36 can modify or assist in modifying the operational speed 44 of the motor 34 and can also modify the delivery speed 110 of the conveyor 22. Accordingly, in addressing various agglomerations 14 of scrap material 16, the shredding tool 10 may maintain a consistent shredding speed 26 while the conveyor 22 may increase and decrease the delivery speed 110 in response to various agglomerations 14 of scrap material 16 having varying densities 38. The sensors 36 may also be utilized to vary the shredding speed 26 of the shredding tool 10 during use of a consistent delivery speed 110 of the conveyor 22 for delivering the agglomerations 14 of scrap material 16 toward the shredding tool 10. It is contemplated that both the shredding tool 10 and the conveyor 22 can be adjusted or modulated in velocity. By way of example, and not limitation, where a flow of scrap material 16 having a lower density 62 is moved through the shredding apparatus 12, the conveyor 22 and the shredding tool 10 may be increased in velocity to provide more expedient processing of the scrap material 16. Conversely, where the agglomerations 14 of scrap material 16 have agglomerations 14 of a higher density 60 that are being processed, the shredding tool 10 and the conveyor 22 may each be slowed to better process the agglomerations 14.

In various aspects of the device, as exemplified in FIGS. 1-7, the sensor 36 or sensors 36 can be positioned on the shredding tool 10. The sensor 36 or sensors 36 can also be positioned in varying positions within the shredding apparatus 12. By way of example, and not limitation, one sensor 36 may be positioned on the shredding tool 10 and another sensor 36 may be positioned at or near the conveyor 22. One sensor 36 may be used for monitoring the density 38 of the agglomerations 14 of the scrap material 16. It is also contemplated that multiple sensors 36 can be utilized throughout the shredding apparatus 12 to monitor varying densities 38 of the agglomerations 14 of scrap material 16 moving through the shredding apparatus 12.

Referring again to FIGS. 1-4, the shredding tool 10 can take the form of a shredding disc 120 that is rotationally operable by the variable speed motor 34. The shredding disc 120 can include a plurality of teeth 28 or other protrusions 122 that can engage and separate various portions of the agglomerations 14 of scrap material 16 for processing within the shredding apparatus 12. The various teeth 28 can be manipulated to handle varying types of scrap material 16. Various finger-type protrusions 122 can also be included in the shredding tool 10 for use in processing the agglomerations 14 of scrap material 16.

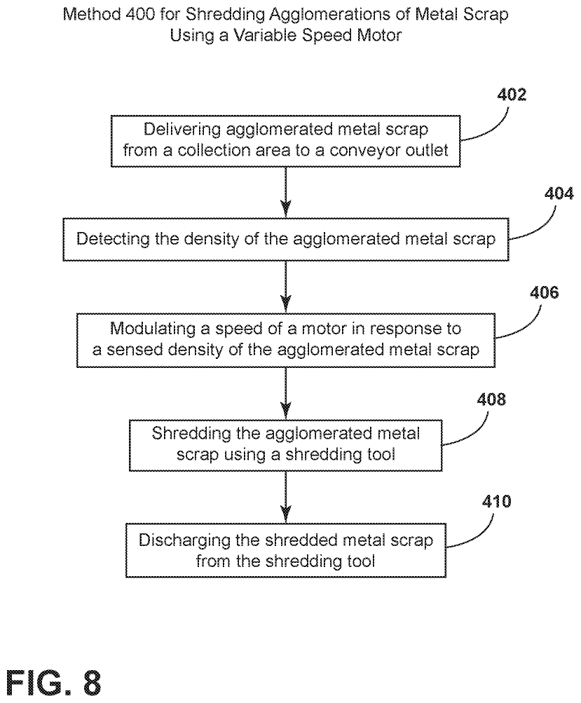

Referring now to FIGS. 1-8, having described various aspects of the shredding apparatus 12, a method 400 is disclosed for shredding agglomerations 14 of metal scrap 18 utilizing a variable speed motor 34. According to the method 400, a step 402 can include delivering agglomerations 14 of metal scrap 18 from a collection area 20 to a conveyor outlet 24 via a screw-type conveyor. As discussed above, the conveyor 22 can include an auger 70, screw-type conveyor, belt-type conveyor, or other material handling assembly that can move the agglomerations 14 of metal scrap 18 from the collection area 20 and toward the shredding tool 10.

According to the method 400, the sensor or sensors 36 are used for detecting the density 38 of the agglomerations 14 of metal scrap 18 within the screw-type conveyor 22 (step 404). The method 400 also includes a step 406 of modulating the operational speed 44 of the variable speed motor 34 in response to a sensed density 42 of the agglomerations 14 of metal scrap 18. The operational speed 44 of the motor 34 is modulated such that the modulation occurs before the agglomeration 14 of metal scrap 18 having a higher density 60 reaches the conveyor outlet 24 and causes a potential blockage of the shredding apparatus 12. To assist in modulating the operational speed 44 of the variable speed motor 34, a controller 40 placed in communication with the sensor 36 and the variable speed motor 34 can be utilized. During operation of the shredding apparatus 12, the sensor 36 communicates a sensed density 42 of the agglomerations 14 of metal scrap 18 to the controller 40. The controller 40 uses the sensed density 42 from the sensor 36 to modulate the operational speed 44 of the variable speed motor 34 based upon the sensed density 42 of the agglomerations 14 of metal scrap 18. The sensed density 42 delivered to the controller 40 can result in the controller 40 increasing or decreasing the operational speed 44 of the variable speed motor 34, and, in turn, the shredding tool 10.

Various testing of the device has shown that an increased shredding speed 26 of the shredding tool 10 is proficient at shredding agglomerations 14 of metal scrap 18 having a lower density 62. Also, testing has shown that a lower operational speed 44 or slower shredding speed 26 of the shredding tool 10 is proficient at processing agglomerations 14 of the metal scrap 18 having a higher density 60. It is contemplated that depending upon the material being processed, a high-operational speed 44 or high shredding speed 26 of the shredding tool 10 may be useful in processing agglomerations 14 of a higher density 60 of a particular material. Conversely, agglomerations 14 of a lower-density 62 may be better processed utilizing a low operational speed 44 of the variable speed motor 34 and the shredding tool 10. The appropriate speeds for processing the various agglomerations 14 of scrap material 16 may vary depending upon the character and quality of the scrap material 16 being processed. The shredding apparatus 12 may be utilized for processing metal scrap 18, as well as other materials that may include, but are not limited to, wood, plastic, composite materials, combinations thereof, and other similar materials.

Referring again to FIGS. 1-8, according to the method 400, the agglomerations 14 of scrap material 16 can be shredded using the shredding tool 10 located proximate the conveyor outlet 24 (step 408). In this shredding step 408, the sensor 36 may be one of a torque sensor, a noise sensor, a vibration sensor, various weight scales, movement sensors, accelerometers, optical sensors, ultra-sound sensors, laser sensors, infrared sensors, combinations thereof and other similar sensors 36 that can be used to detect, directly or indirectly, various characteristics of the agglomerations 14 of scrap material 16 moving through the conveyor 22 and toward the shredding tool 10. Typically, the sensor 36 may be attached to the shredding tool 10. It is also contemplated that one or more sensors 36 may be attached to an area within or near the conveyor 22 for the shredding apparatus 12. According to the method 400, a step 410 includes discharging the processed material 32 from the shredding tool 10 to a scrap separator 130. As discussed previously, the scrap separator 130 may separate the shredded metal scrap 18 into various categories of processed material 32 similar to those described above.

According to various aspects of the device, the shredding apparatus 12 utilizing the variable speed motor 34 that can be controlled by one or more sensors 36 can be useful in processing agglomerations 14 of metal scraps 18 or other scrap material 16. By using the sensors 36 proximate the shredding tool 10 and/or within the conveyor 22, the variable speed motor 34 can be modulated to provide an appropriate operational speed 44 for processing agglomerations 14 of scrap material 16 having varying densities 38. By varying the operational speed 44 of the variable speed motor 34, and the shredding speed 26 of the shredding tool 10, blockages can be substantially prevented during processing of scrap material 16. By limiting or avoiding blockages, greater amounts of scrap material 16 can be processed over time. Additionally, reversal of the conveyor 22 for the shredding apparatus 12 can also be avoided by modulating the speed of the variable speed motor 34 to better process the agglomerations 14 of scrap material 16, having a higher density 60.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A shredding apparatus for separating scrap material, the shredding apparatus comprising:
a conveyor that delivers agglomerations of metal scrap from a collection area to a conveyor outlet;
a shredding tool positioned proximate the conveyor outlet, wherein the shredding tool is rotationally operable between a plurality of shredding speeds and wherein the shredding tool includes a plurality of teeth that shred the agglomerations of metal scrap for delivery to an outlet section;
a variable speed motor coupled with the shredding tool, wherein the variable speed motor rotationally operates the shredding tool to selectively define the plurality of shredding speeds;
a sensor positioned proximate one of the shredding tool and the conveyor, wherein the sensor monitors a density of the agglomerations of metal scrap; and
a controller in communication with the sensor and the variable speed motor, wherein the sensor communicates the density of the agglomerations of metal scrap to the controller and the controller modulates an operational speed of the variable speed motor based upon the density of the agglomerations of metal scrap.

2. The shredding apparatus of claim 1, wherein the sensor and controller cooperatively define a first operating speed of the variable speed motor in response to the density of the agglomerations of metal scrap having a first density, and wherein the sensor and the controller cooperatively define a second operating speed of the variable speed motor in response to the density of the agglomerations of metal scrap having a second density.

3. The shredding apparatus of claim 2, wherein the first operating speed of the variable speed motor is faster than the second operating speed of the variable speed motor and wherein the second density is greater than the first density.

4. The shredding apparatus of claim 1, wherein the conveyor includes an auger rotationally operable within a conveyor housing.

5. The shredding apparatus of claim 4, wherein the auger includes an end section positioned proximate the conveyor outlet, and wherein the plurality of teeth of the shredding tool cooperatively shred the agglomerations of metal scrap for delivery to an outlet section.

6. The shredding apparatus of claim 1, further comprising:
a centrifuge positioned to receive shredded metal scrap from the shredding tool, the centrifuge being configured to remove liquid from the shredded metal scrap.

7. The shredding apparatus of claim 4, wherein the sensor is a torque sensor that detects a resistance experienced by the variable speed motor during operation of the shredding tool.

8. The shredding apparatus of claim 3, wherein the sensor is a noise sensor, wherein an increased noise is indicative of the second density.

9. The shredding apparatus of claim 1, wherein the variable speed motor and the conveyor operate to shred the agglomerations of metal scrap in a manner that is free of a reverse direction that moves the agglomerations of metal scrap away from the shredding tool.

10. The shredding apparatus of claim 1, wherein the sensor is positioned on the shredding tool.

11. A shredding apparatus for separating scrap material, the shredding apparatus comprising:
a screw-type conveyor that delivers agglomerations of metal scrap from a collection area to a conveyor outlet;
a shredding tool positioned proximate the conveyor outlet, wherein the shredding tool includes a plurality of teeth that shred the agglomerations of metal scrap for delivery to an outlet section;
a sensor positioned proximate one of the shredding tool and the screw-type conveyor, wherein the sensor monitors a density of the agglomerations of metal scrap within the screw-type conveyor to define a sensed density; and
a variable speed motor coupled with the shredding tool, wherein operation of the variable speed motor rotationally operates the shredding tool to selectively define a plurality of operating speeds of the shredding tool, wherein the sensed density of the agglomerations of metal scrap defines an operating speed of the variable speed motor and the shredding tool.

12. The shredding apparatus of claim 11, further comprising:
a controller in communication with the sensor and the variable speed motor, wherein the sensor communicates the sensed density of the agglomerations of metal scrap to the controller, and wherein the controller modulates the operating speed of the variable speed motor based upon the sensed density of the agglomerations of metal scrap.

13. The shredding apparatus of claim 11, wherein the sensor and controller cooperatively define a first operational speed of the variable speed motor in response to the sensed density of the agglomerations of metal scrap having a first density, and wherein the sensor and the controller cooperatively define a second operational speed of the variable speed motor in response to the sensed density of the agglomerations of metal scrap having a second density.

14. The shredding apparatus of claim 13, wherein the first operational speed of the variable speed motor is faster than the second operational speed of the variable speed motor and wherein the second density is greater than the first density.

15. The shredding apparatus of claim 11, wherein the screw-type conveyor includes an end section positioned proximate the conveyor outlet, and wherein the plurality of teeth of the shredding tool cooperatively shred the agglomerations of metal scrap for delivery to the outlet section.

16. The shredding apparatus of claim 14, wherein the sensor is a torque sensor that detects a resistance experienced by the screw-type conveyor.

17. The shredding apparatus of claim 14, wherein the sensor is a noise sensor, wherein an increased noise is indicative of the second density.

18. The shredding apparatus of claim 11, wherein the variable speed motor and the screw-type conveyor operate to shred the agglomerations of metal scrap in a manner that is free of a reverse direction that moves the agglomerations of metal scrap away from the shredding tool.

19. The shredding apparatus of claim 11, wherein the sensor is positioned on the shredding tool.

20. A method of shredding scrap material comprising steps of:
delivering agglomerations of metal scrap from a collection area to a conveyor outlet via a screw-type conveyor;
detecting a density of the agglomerations of metal scrap within the screw-type conveyor using a sensor;
modulating a speed of a motor in response to a sensed density of the agglomerations of metal scrap, wherein the speed of the motor is modulated before a blockage reaches the conveyor outlet;
shredding the agglomerations of metal scrap using a shredding tool located proximate the conveyor outlet, wherein the sensor is one of a decibel sensor and a torque sensor that is attached to the shredding tool; and
discharging shredded metal scrap from the shredding tool to a scrap separator.
